(19) United States
(12) Patent Application Publication
(10) Pub. No.: US 2004/0234938 A1
(43) Pub. Date: Nov. 25, 2004

(54) System and method for providing instructional feedback to a user

(75) Inventors: Susan D. Woolf, Seattle, WA (US); Roland L. Fernandez, Woodinville, WA (US); Arin J. Goldberg, Woodinville, WA (US); Wistar D. Rinearson, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/744,377

(22) Filed: Dec. 23, 2003

Related U.S. Application Data
(60) Provisional application No. 60/471,984, filed on May 19, 2003.

(51) Int. Cl. G09B 7/00

(52) U.S. Cl. 434/353

(57) ABSTRACT

A system and method for providing instructional responses to unstructured user input is presented. In operation, a task is presented to a user. In response to the task, the user inputs unstructured input onto a computing device. In response to the input, a determination is made as to whether an instructional response should be presented to the user. If so, the response is presented to the user. Determining whether a response should be made to the user is made according to the accuracy of the user input in regard to the task. The response may be a visual response, and audio response, or an audio/visual response. The invention may be used in a network configuration that permits a teacher to monitor the progress of individual users/students.

### FIELD OF THE INVENTION

The present invention relates to a system and method for providing instructional feedback to a user, and more particularly, to a system and method for accepting unstructured user input in response to a specific task and providing instructional feedback to the user based on the unstructured input in regard to the specific task.

### BACKGROUND OF THE INVENTION

Computers have penetrated many aspects of today's society. In fact, it is sometimes difficult to identify areas of everyday life where computers are not applied. However, in regard to education, computers have not made significant inroads and, in many cases, have proved counterproductive. This is especially true in early educational learning.

Early education, as well as many other aspects of education, often focuses on the process of arriving at a “destination,” rather than at the “destination” itself. In other words, the focus of many teachers, and early education teachers especially, is more at teaching the correct process, not just jumping to the correct answer. For example, when teaching young children to write, the process of correctly forming, or writing, a character is as important as recognizing the character when written. Thus, learning to properly form the letter “B” is just as important to one learning to write as being able to recognize the letter “B” when written. Similarly, the correct answer to a long division problem is not always as important as the process by which it is obtained.

One of the reasons that computers have not had as great an impact on education is that computers have traditionally imposed very structured requirements on input, and, as such, are result-oriented. For example, educational software focusing on mathematics typically evaluates the ultimate answer a user enters (via a keyboard), rather than the process by which the user arrives at the answer. Similarly, a user does not actually write a letter “B” out on the screen, but rather types the letter “B” by pressing a key appropriately labeled on a keyboard. In such situations, while the user may become more efficient at typing, the user is probably not learning to form the letter. Clearly, teaching the correct process/technique is not addressed by educational software.

What is needed is a system and method for accepting unstructured input from a user in response to a particular task, and providing instructional feedback based on the accuracy of the user input to the particular task. The present invention addresses these and other issues found in the prior art.

### SUMMARY OF THE INVENTION

In accordance with aspects of the present invention, a computing device for providing instructional responses to a user is provided. The computing device includes an input device that accepts unstructured user input, and an output device. The computing device, in response to a task presented to a user, accepts the unstructured input from the user via the input device. The computing device then determines whether an instructional response should be output, and if so, outputs an instructional response.

In accordance with other aspects of the present invention, a networked computing system for monitoring the activities of a plurality of students on computing devices to a task is presented. The networked computing system includes an instructor computer and a plurality of computing devices connected to the instructor computer via a communication network connection. Each computing device includes an input module and an output module. In response to a presented task, each computing device is operable to accept unstructured input from a user via the input module, and determine whether an instructional response should be provided to the user of the computing device.

In accordance with yet further aspects of the present invention, a computer-readable medium having computer-executable instructions is presented. The computer-executable instructions, when executed on a computing device, carry out the method comprising accepting unstructured input from a user via an input module in response to a presented task, and determining whether an instructional response should be output on the computing device. If it is determined that an instructional response should be output, the method outputs the response via the output device.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary computing device suitable for implementing aspects of the present invention;

FIG. 2 is a pictorial diagram of an exemplary user interface screen for accepting unstructured user input in response to a particular task;

FIGS. 3A-3D are pictorial diagrams illustrating a user interface for accepting unstructured user input and the process of evaluating user input and providing instructional feedback in response to the user input;

FIG. 4 is a pictorial diagram illustrating yet another user interface for accepting unstructured user input and providing instructional feedback to a particular task, presented in an entertainment format;

FIG. 5 is a pictorial diagram illustrating another user interface of an application of the present invention in regard to learning phonics;

FIG. 6 is a flow diagram illustrating an exemplary process for accepting unstructured user input determining the accuracy of the unstructured input, providing feedback to the user based on the user input with respect to the task;

FIG. 7 is a pictorial diagram illustrating an exemplary multi-user, networked environment suitable for implementing aspects of the present invention; and

FIGS. 8A and 8B are pictorial diagrams illustrating an exemplary user interface on an instructor computer for evaluating the progress of students in the exemplary networked environment.

### DETAILED DESCRIPTION OF THE PREFERRED EMBODIMENT

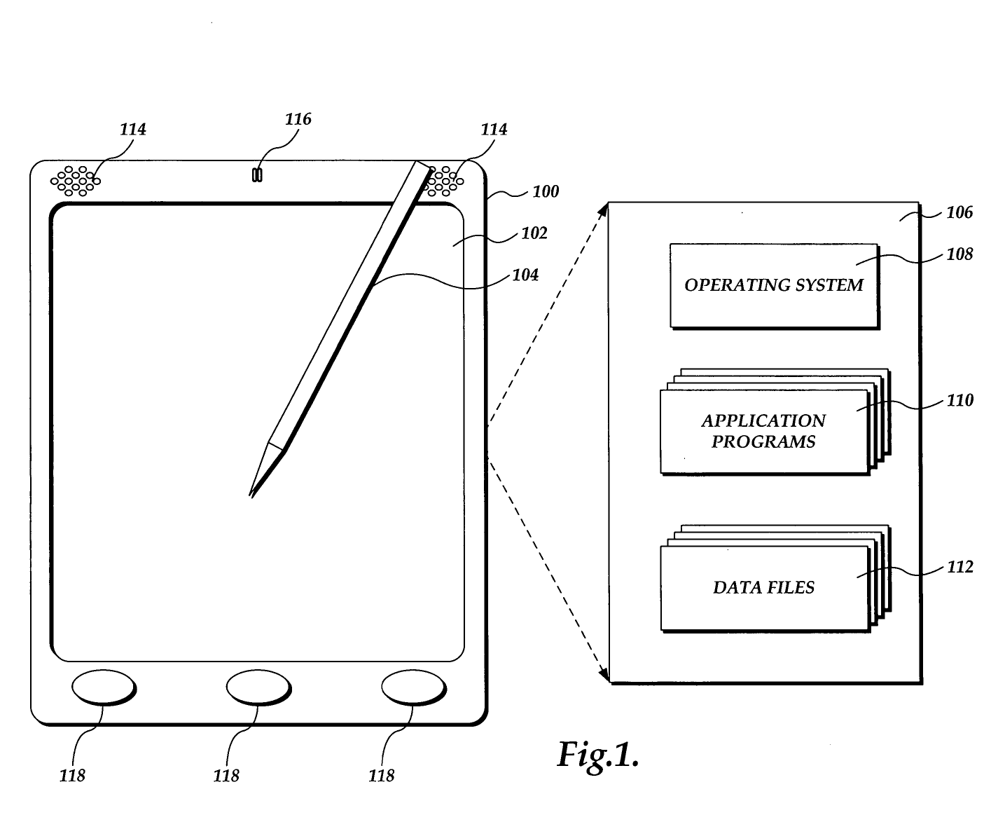

FIG. 1 and the following discussion are intended to provide a brief, general description of a system suitable for implementing various features of the invention. While the system will be described in the general context of a tablet computer, those skilled in the art will appreciate that the invention may be practiced on other computing systems, including personal digital assistants, desktop computers with specially adapted input/output devices, and the like.

Additionally, while aspects of the invention may be described in terms of application programs that run on an operating system in conjunction with a tablet computer, those skilled in the art will recognize that those aspects also may be implemented in combination with other program modules. Generally, program modules include routines, programs, components, data structures, etc., that perform particular tasks or implement particular abstract data types.

With reference to FIG. 1, as described above, an exemplary system includes a tablet device 100. Those skilled in the art will recognize that a tablet device 100 includes a combined input/output display device 102. The combined input/output display device 102 may be a touch, or pressure-sensitive screen upon which a user may enter information, and also upon which the tablet device displays the user's input, as well as other information. Typically, a user enters information via the combined input/output display device 102 using a pencil-like instrument, frequently referred to as the stylus 104. In addition to, or as an alternative to, being touch or pressure-sensitive, those skilled in the art will also recognize that many of the combined input/output display devices 102 may alternatively detect, and react to, a conforming stylus 104 when the stylus is in proximity to, but not in actual contact with, the display device. For example, a cursor on the combined input/output display device 102 may correspond to the position of a conforming stylus 104 as the stylus is moved around, but just above, the display device, while program modules on the tablet devices accept input information.

Those skilled in the art will recognize that other mechanisms for a stylus-like device to interact with a combined input/output device are also available. Thus, while the remainder of this discussion will make reference to the combined input/output display device 102 as using a pressure sensitive stylus, it should be understood that it is for illustration purposes only, and should not be construed as limiting upon the present invention.

The tablet device 100 also includes a processor (not shown) and a storage 106, comprising both volatile and non-volatile memory areas. The storage 106 includes an operating system 108, one or more application programs 110, as well as data files 112. As previously mentioned, aspects of the present invention may be implemented as an application program running on the tablet device 100.

Those skilled in the art will also recognize that a tablet device 100 also typically includes other components, such as integrated speakers 114, and an integrated microphone 116. Still other components (not shown) include a modem and/or a network connection (either wired or wireless), disk drives, peripheral connects such as Universal Serial Bus (USB) and IEEE 1394 connectors, and the like. An exemplary tablet device 100 may also include various physical control devices, such as controls 118, that may represent a power switch, volume and contrast controls, or other controls having specific assigned functions, such as launching an e-mail program.

While many tablet computing devices permit an external keyboard to be attached, it is through the pressure-sensitive input device that the tablet device receives unstructured input. In most circumstances, keyboards generate structured input. For example, when a user presses the letter “B” on the keyboard, a corresponding value representing the letter “B” is received by the computer. As each key on the keyboard represents a specific value, and only those values corresponding to a permissible sequence of pressed keys are sent from the keyboard to a computer, a keyboard's input is determinative and structured. In contrast, input from a pressure-sensitive input device may be free-formed, or unstructured. For example, if a user, via the stylus or some other implement suitable for “writing” on the input device, forms the letter “B”, the data itself corresponds to a sequence of vectors and arcs, or to a set of bits in an image that appear as the letter “B”. The unstructured input does not, of itself, represent a value corresponding to “B” to the tablet device, unless and until some other program or process interprets that data and translates it to the corresponding value.

While the above discussion describes unstructured input as data entered via a stylus on an input device, it is illustrative, and should not be construed as limiting upon the present invention. Unstructured input may take on many other forms, including, but not limited to, oral/audio responses and visually captured responses.

Because a tablet device is capable of accepting unstructured input, via a stylus/input device combination, microphone, or via an attached (or integrated) camera, the tablet device is well adapted for certain educational situations, namely those where an evaluation of unstructured input is important. As discussed, learning to write letters or numbers, and the process involved in certain mathematical operations, are just some examples. Another reason why the tablet device is well adapted for these educational situations is that a combined input/output display device outputs the user's unstructured input in place, i.e., the same location where the input was received. Thus, the user sees the data as it is input.

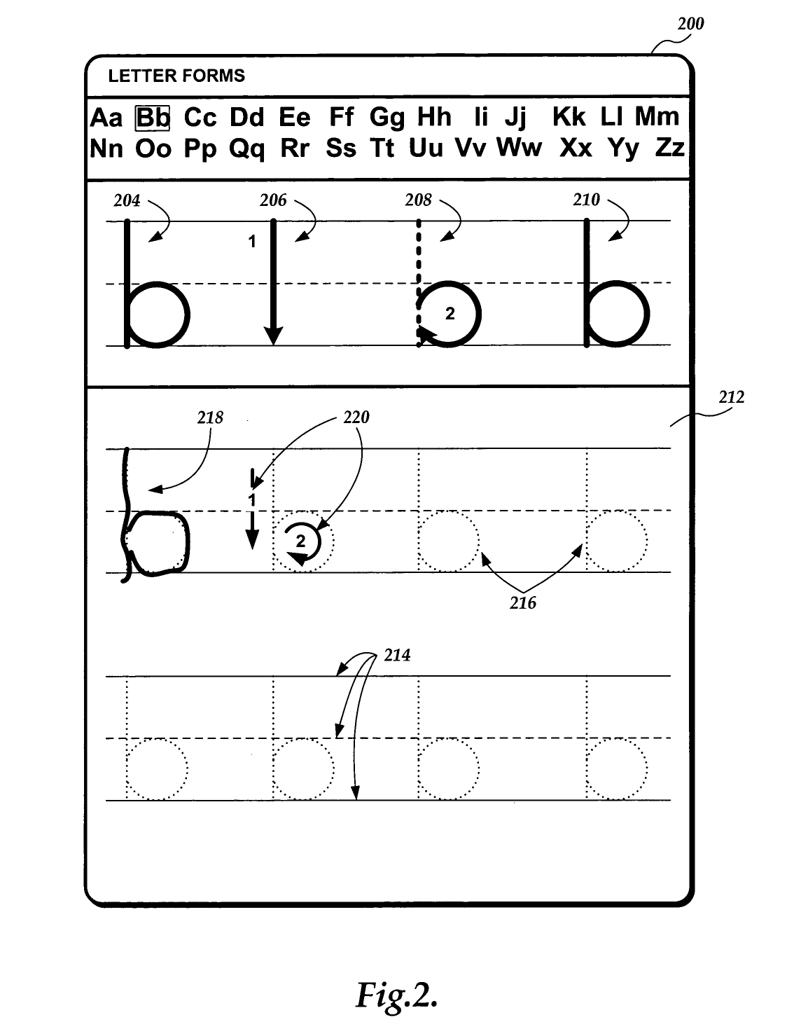

According to the present invention, a program module, such as one of the application programs 110 mentioned above, receives the unstructured information and may provide feedback to the user. FIG. 2 is a pictorial diagram of an exemplary user interface 200 for an application 110 that accepts unstructured user input in response to a particular task. The user interface 200 is representative of an educational program to teach a student to write letters/characters. The exemplary user interface 200 includes an instruction area that presents a completed character 204, student instructions illustrating the proper sequence, 206 and 208, for forming the character, and another completed character 210.

A practice region 212 provides an area with the lines 214 and guides 216 on which a student may practice forming a letter, in this case the letter “b”. A student's attempt is illustrated as 218. As previously mentioned, as a user (in this case a student) provides unstructured input, a program module evaluates the input for accuracy, as well as opportunities to provide instructional feedback. For example, the student's attempt 218 is relatively accurate, and forms a passable letter “b” for someone learning to write. Thus, according to the end result, the student's effort was a success. However, as described above, the process is sometimes as important as the end result. If the student formed the letter by drawing the circle portion first, then a long line, a response from the program module may be appropriate, indicating the correct order 220 to form the letter. Alternatively, if the student had formed the attempt 218 in the proper order, then perhaps the appropriate response is no immediate feedback.

According to one aspect of the present invention, the user's input is continually evaluated to determine whether instructional feedback should be provided. For example, once an error is detected, instructional feedback may be provided even while the user is providing further input. Thus, referring to the example above, if the user inputs the circle portion of the letter “b” before the long line, an instructional feedback message indicating the “error” may be provided while the student completes the letter. Alternatively, the user's input may be evaluated at the completion of the presented task, when the user ceases to supply further input, or after a set or series of presented tasks have been completed.

As shown in FIG. 2, a response to a user's input may be made in the form of additional visual suggestions or hints for completing the task, such as indicating the correct order 220 to form a particular letter. However, responses/feedback may be made in a variety of manners, including audio responses, flashing visual response, pop-up windows, and the like, as well as any number of combinations of them. The responses may include encouragements, corrections, analysis, congratulations, and the like. Accordingly, the present invention should not be viewed as limited to any particular response.

According to aspects of the present invention, the determination as to whether instructional feedback is to be displayed to the user is made according to predetermined criteria in regard to the presented task. For example, the user's unstructured input in forming the letter “b” 218 may be evaluated according to the order that elements of the letter are formed/input, the accuracy of the element's shapes, the size of the various elements according to the space provided and/or according to the proportions of all of the input elements, and deviations from displayed guides, to name just a few. According to further aspects of the present invention, the evaluation may be based upon an exemplary input. In other words, a teacher, or some other person, may establish a template-like input that forms the letter. For example, a teacher may record the teacher's input while forming the letter “b”, which becomes a template, or example, for the students to follow. Thereafter, the teacher's recorded input is used to evaluate the student's efforts to determine if instructional feedback is appropriate. As an instructional aid, the teacher's exemplary input may be displayed in the user's input area, such that the user can trace the teacher's input as a learning aid.

It should be understood that while several exemplary factors for evaluating the user's unstructured input are put forth, they are illustrative only, and should not be construed as limiting upon the present invention. Numerous other ways for evaluating the accuracy of the user's unstructured input in regard to a specific, presented task may be utilized in the present invention without departing from the scope thereof.

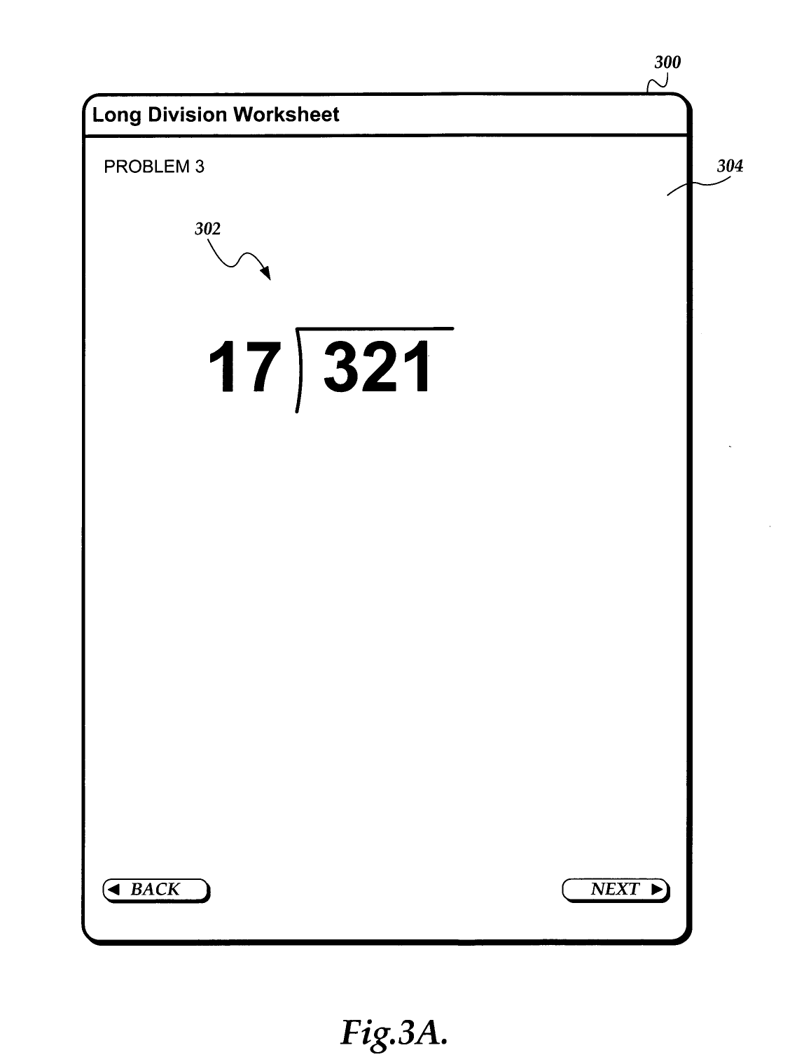

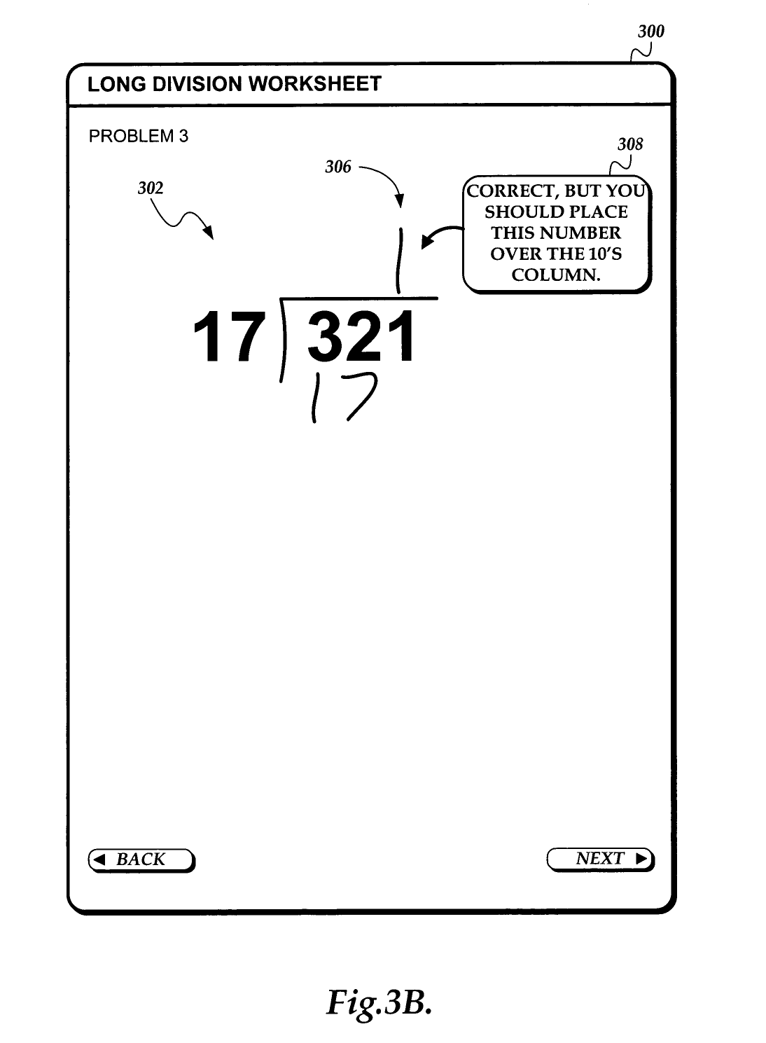

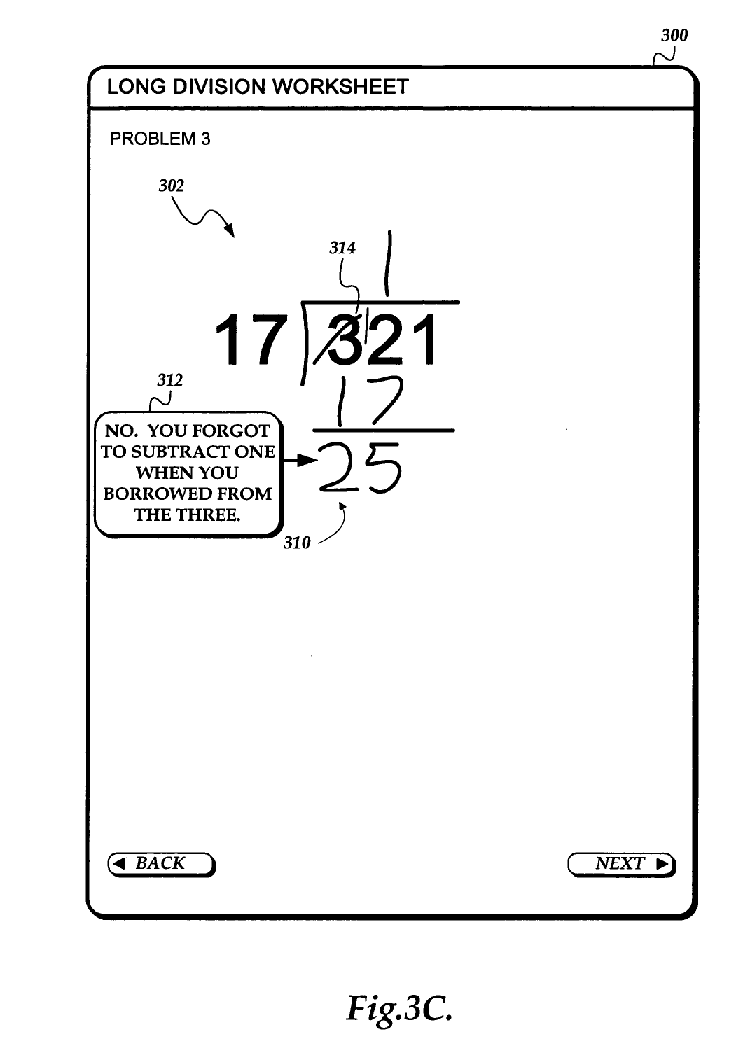

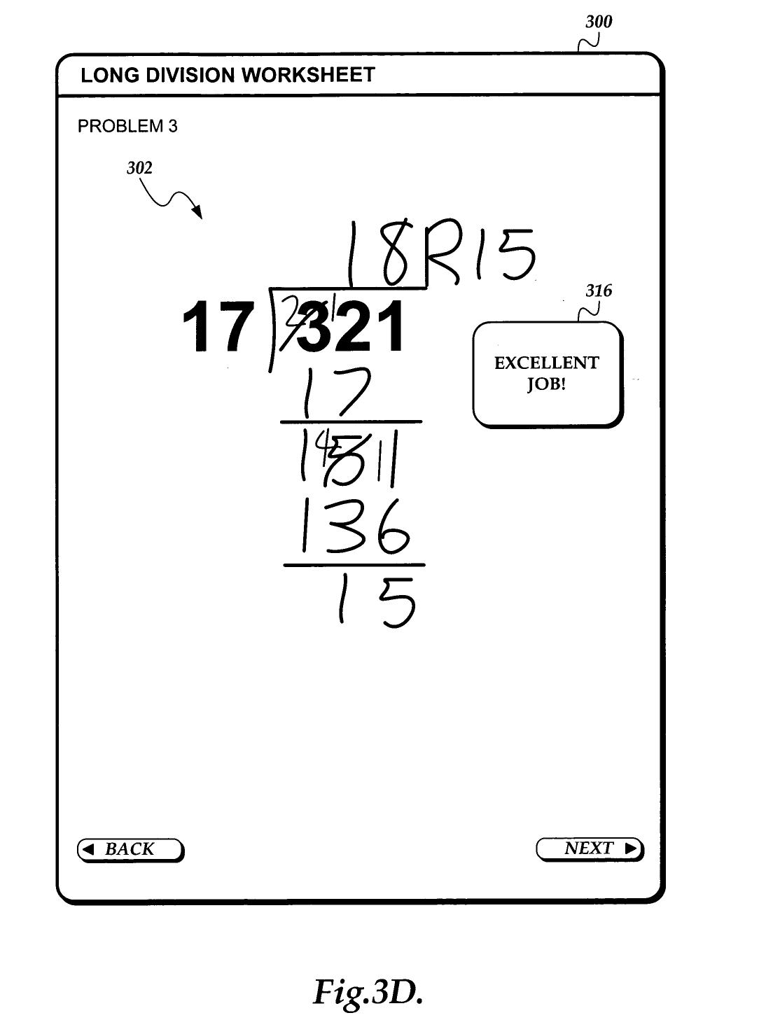

FIGS. 3A-3D are pictorial diagrams illustrating another exemplary user interface 300 for presenting a task, accepting unstructured user input, evaluating the input, and providing instructional feedback in response to the user input. As shown in FIG. 3A, the task presented to the user is to complete the long division task 302 presented. In this example, the input area includes almost the entire interface screen 304.

With reference to FIG. 3B, as the user enters the unstructured input, the input is evaluated for accuracy, and a response, if appropriate, is given. In this example, the accuracy of the input is determined according to whether the user formed the correct numerals, and also whether the location of the input was appropriate. As shown in regard to the long division task 302, the input representing the number “1” 304 was incorrectly located. In response, an instruction window 306 is displayed, providing the user with both positive feedback, as well as correctional information.

Referring now to FIG. 3C, after the location error is corrected and the user continues with the long division task 302, yet another user error is detected in a subtraction step of the task. In this case, the user's input was evaluated not only according to a numeric value, but in terms of the process by which the value was derived. As shown in FIG. 3C, the user properly borrowed from the “3” to complete the first portion of the subtraction process, but apparently failed to decrement the “3” when performing the second portion of the subtraction, as indicated by arrow 310. Thus, an instruction window 312 is displayed that provides appropriate instruction according to the process, not simply the results.

As can be seen in FIG. 3C, unstructured user input does not always correspond to numbers or letters. For example, in the process of long division, it may be important for a teacher to require that students, when “borrowing” from a higher placed value, such as borrowing the “3” described above, cross out the value from which the borrowing occurred. For example, the “3” in FIG. 3C has a line 314 through it, indicating that the number should be reduced. Thus, according to aspects of the present invention, the line through the “3” would be detected as unstructured user input and evaluated for accuracy against the specific task. Failure to input the line through the “3”, indicating that the number should be decremented later, may result in an instructional window being displayed to the user. According to the example of FIG. 3C, the user further omitted writing a “2” next to a crossed-out “3”. Instructional feedback to this omission may also be appropriate.

Referring now to FIG. 3D, after corrections are made, and when it is detected that the user correctly completes the long division task 302, yet another instruction window 316 is displayed, this time as a congratulations for successfully finishing the task.

As can be seen from the above examples, unlike prior art educational programs, the present invention accepts unstructured user input, evaluates the input against a specific task, and provides instructional feedback to the user. Additionally, unlike traditional teaching environments, the user may be provided with immediate instructional feedback, rather than competing for the limited time of a teacher.

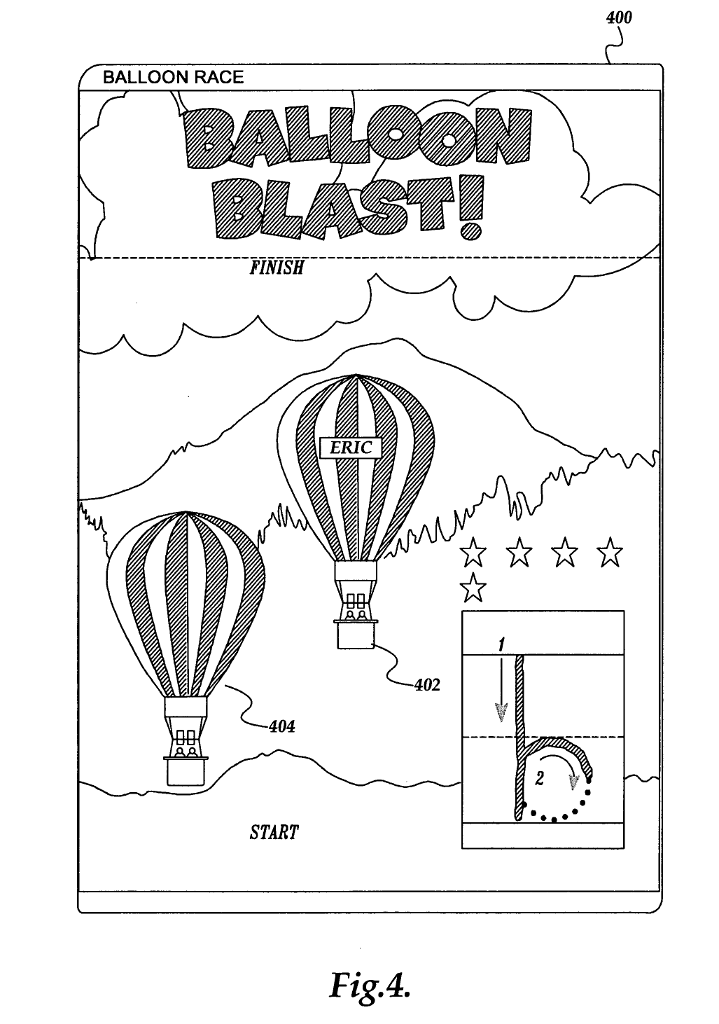

As with many educational activities, in addition to providing a purely educational environment, the present invention may be adapted to combine elements of entertainment with education. FIG. 4 is a pictorial diagram illustrating yet another exemplary user interface 400 for accepting unstructured user input and providing instructional feedback to a particular task combined with entertainment aspects. According to the illustrated example, a user competes against the tablet device 100. The user is attempting to move the user's balloon 402 to the finish line before the tablet device 100 moves its balloon 404 to the finish line. The user moves the user's balloon 402 up by successfully writing the letter “b” in the input box 406. According to the speed and accuracy of the user's input, the user's balloon moves up. As can be seen in this example, the instructional feedback is provided in an alternative manner from that described above. In this case, the instructional feedback may simply be moving the user's balloon 402 according to the accuracy of the user's unstructured input.

While the above-described example is directed to a single user competing against the tablet device 100, it may also be adapted as a multi-user instructional tool, where multiple users compete against each other and/or the tablet device 100. Alternatively, a user may compete against his/her past performances. Thus, the above example should be viewed as illustrative and limiting upon the present invention.

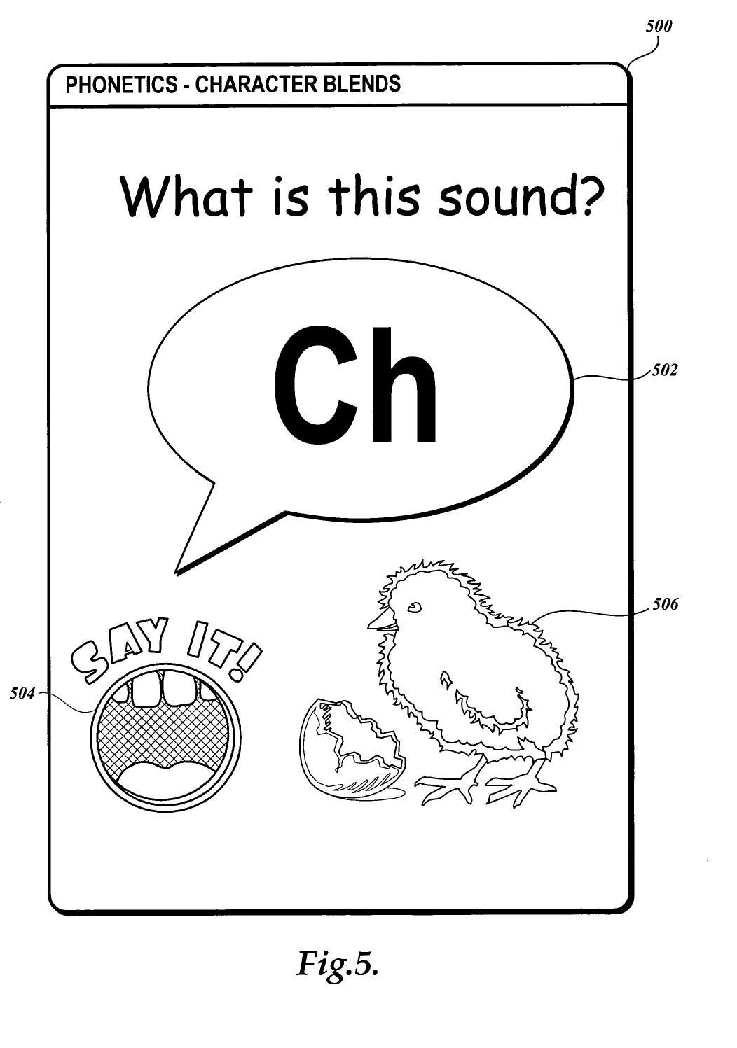

In addition to the above described examples, the present invention may be advantageously used in other learning situations. For example, the present invention may be applied to phonetic teaching/learning situations. FIG. 5 is a pictorial diagram illustrating an exemplary user interface 500 showing an application of the present invention in regard to learning phonics. As shown in FIG. 5, a task 502 is presented to the user/student, particularly to audibly sound the combined letters “Ch”. A visual prompt 504 is also provided to prompt the user to make the sound of the combined letters in the task. The user's input, in this case audibly making the sound from combining the two letters, is gathered via a microphone, such as the integrated microphone 116 of FIG. 1. Additionally or alternatively, the prompt to “say” the combined letters may be an audio prompt. As before, as the user inputs the unstructured input, in this case audio sound, they are analyzed to determine whether instructional feedback is appropriate. FIG. 5 also illustrates that visual clues may be offered to the user, such as the chick image 506, to help the user properly respond to the presented task. As with the other examples previously described, an instructional response may be audio, visual, or a combination of the two.

While FIGS. 2-5 have presented various applications of the present invention, it should be understood that they are illustrative, and should not be construed as limiting upon the present invention. There are numerous other areas of learning that may also take advantage of gathering unstructured input, determining the accuracy of the input in regard to a presented task, further determining whether an instructional response is appropriate, and if so, providing that instructional response.

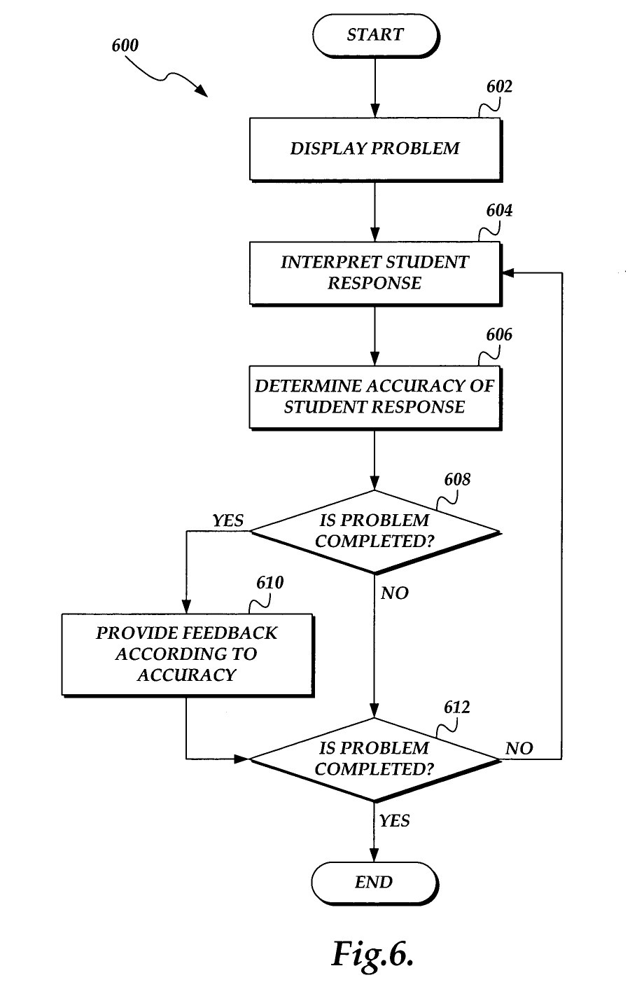

FIG. 6 is a flow diagram illustrating an exemplary routine 600 for accepting unstructured user input in response to a specific task, determining the accuracy of the unstructured input according to the task, and providing feedback to the user based on the accuracy of the unstructured input with respect to the task. At block 602, a task is presented to the user. It should be understood that the task need not be displayed on the output device. According to one alternative aspect of the present invention, the task is presented to the user via the tablet device 100 audio speakers.

At block 604, the user's unstructured input is obtained. At block 606, the accuracy of the unstructured input is evaluated according to the specific task. Evaluating the accuracy of the unstructured input may involve interpreting the input to determine a value entered, determining to what extend a particular sequence is followed, determining to what extent the input is correctly located in regard to the specific task, and the like. Additionally, there may be multiple correct solutions to a presented task. Thus, evaluating the accuracy of the unstructured input may also include determining which of many solutions the user is employing.

At decision block 608, a determination is made as to whether there should be any instructional feedback provided to the user in regard to the user's input. This determination may be based according to predetermined variances from a “perfect” response, according to the user's previous performance, according to a teacher's preference, and the like. Additionally, the instructional feedback may be formed as correctional feedback, encouragement, or positive reinforcement feedback. It should be understood that the basis of determining whether instructional feedback should be provided should not be construed as limited to any particular values or basis. Similarly, the substance or form of the instructional feedback should not be construed as limited to the above described example.

According to aspects of the present invention, the evaluation of the user input, and the determination to provide instructional feedback, are performed on the user's tablet device 102. Alternatively, the evaluation and/or the determination to provide instruction feedback may be performed on another computer, or on a plurality of computers. For example, as will be discussed below, the tablet device may be connected to an instructor computer. Evaluation of the accuracy of the user's input may be more efficiently processed by the instructor computer, which may also determine whether to provide instructional feedback. Thus, the present invention should not be construed as limited to performing the evaluation of user input, and of determining whether to provide instructional feedback, on the user's tablet device.

If instructional feedback should be provided, at block 610, instructional feedback is provided to the user. Alternatively, or after providing feedback to the user, at decision block 612, a further determination is made as to whether the user response to the specified task is completed. This determination may be made according to user's input, according to a positive user action, such as actioning a button indicating completion of the task, or based on the cessation of user input. The present invention should not be limited to any particular manner of determining task completion. If it is determined that the task in not complete, the routine 600 returns to block 604 to obtain further user input. This process continues until, at decision block 612, it is determined that the user's input to the specified task is complete. Thereafter, the routine 600 ends.

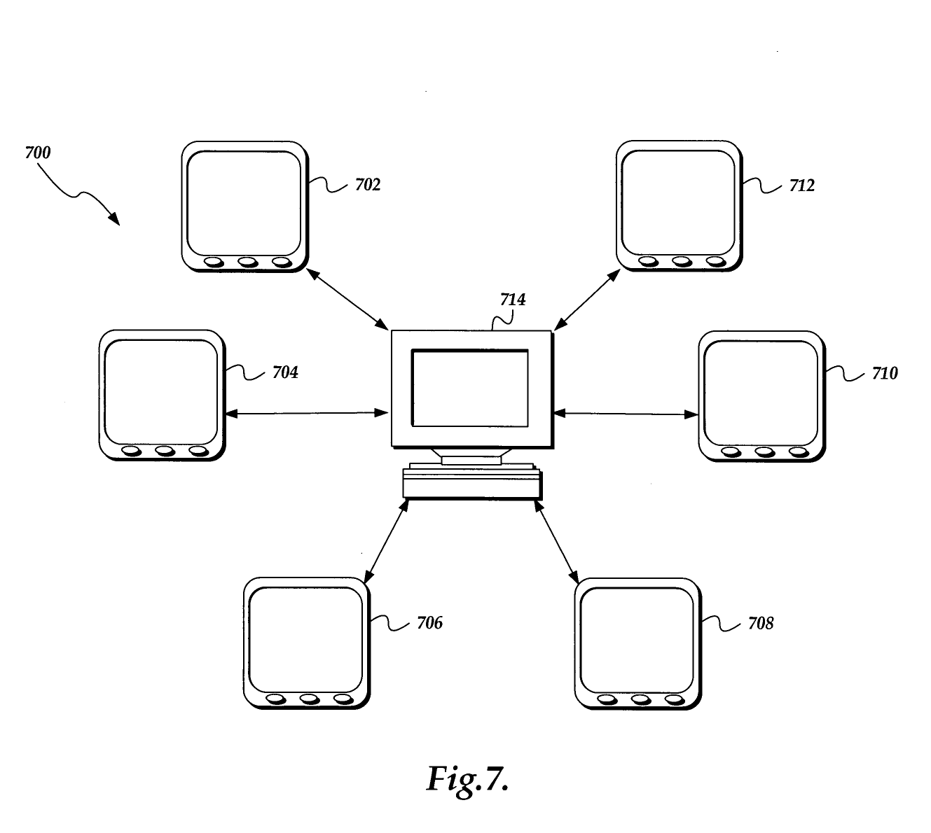

While the present invention has been generally described in terms of a single-user environment, the present invention may be advantageously implemented in a multi-user environment. In particular, the present invention may be advantageously implemented in a classroom type setting. FIG. 7 is a pictorial diagram illustrating an exemplary multi-user, networked environment 700 suitable for implementing aspects of the present invention. The exemplary networked environment includes a plurality of tablet devices, devices 702-712, and a instructor computer 714. The tablet devices 702-712 are all connected to the instructor computer via a communication network.

As shown in FIG. 7, the networked environment 700 is illustrated as configured in a star network, with the instructor computer 714 as the hub. However, this is for illustration purposes only, and should not be construed as limiting on the present invention. Any network configuration may be used. Each device in the networked environment may be connected via a local or remote connection. The connections in the networked environment may be wired connections, or wireless. Further, the instructor computer 714 is illustrated as a desktop computer. However, it should be understood that this, too, is for illustration purposes. Almost any computer may be used as an instructor computer 714, including a desktop computer, a laptop, a tablet computer, and a mini- or mainframe computer.

With the tablet devices adapted to accept unstructured input, analyze the input according to a specific task, and provide instructional feedback according to the accuracy of the input, as well as to report the activity to the instructor computer 714, a teacher's ability to work with students is enhanced. From a single location, i.e., the instructor computer 714, a teacher can evaluate each student's progress in the classroom. The instructor computer may be adapted to present information gathered from the students' tablet devices in a form that will assist the teacher in identifying each student's progress.

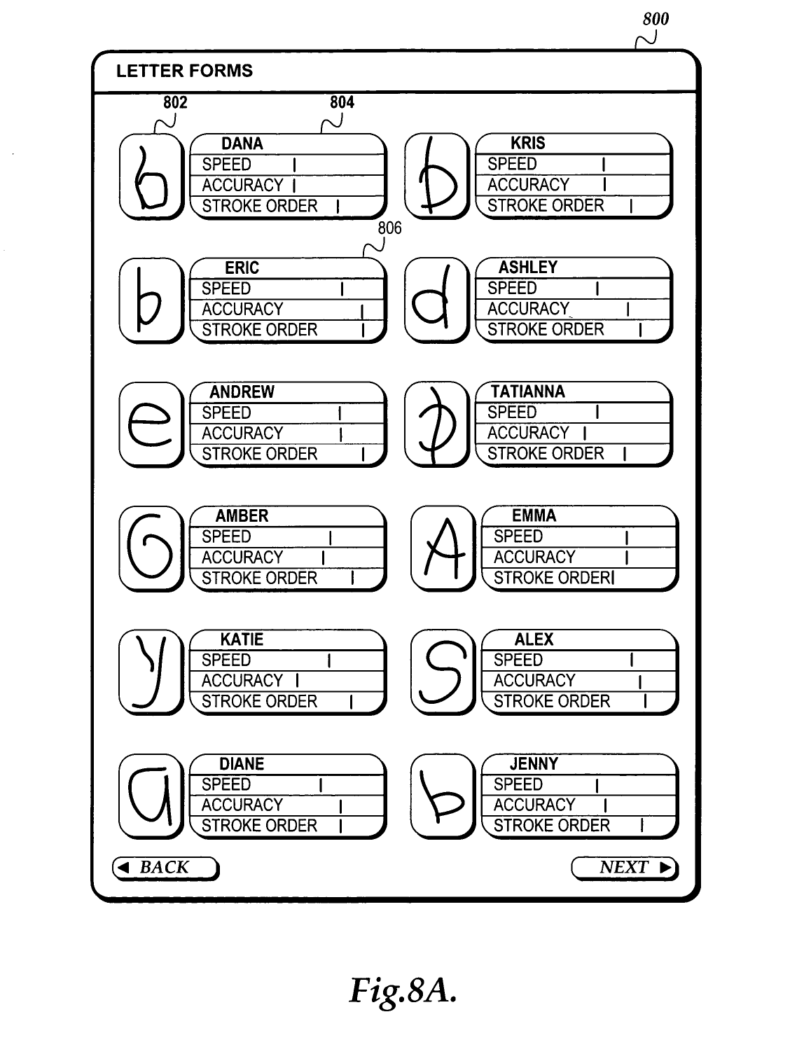

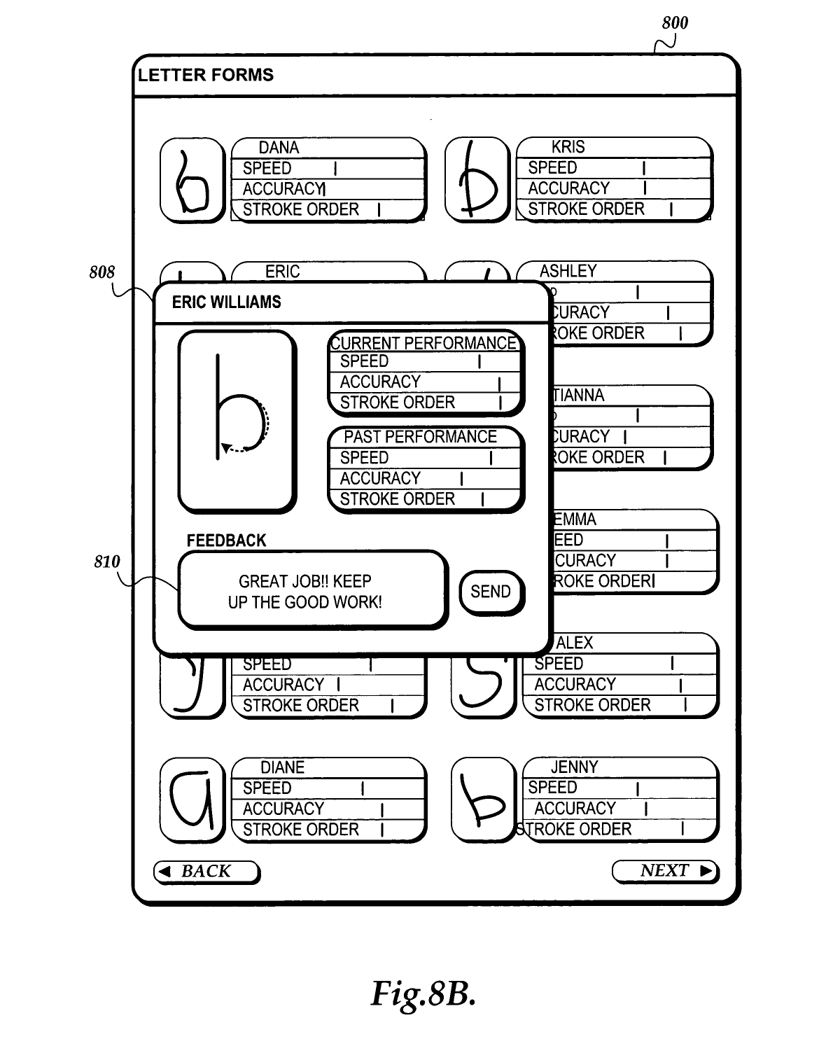

FIG. 8A is a pictorial diagram illustrating a user interface screen 800 on an instructor computer 714 for evaluating the progress of students in the exemplary networked environment 700. As can be seen, the exemplary user interface 800 permits a teacher to quickly evaluate a student's current activities in regard to an assignment/task without spending the time to walk around the room. According to the exemplary user interface, for each user, the student's present activity, such as Dana's letter “b” 802, as well as an evaluation of the student's activity, such as evaluation 804, are provided for each student.

According to other aspects of the invention, in addition to providing automatic instructional responses generated in response to the user's input, a teacher may provide additional feedback, instruction, or encouragement to a student in the exemplary networked environment 700. For example, a teacher may select a particular student for additional information/feedback, such as by double clicking on the current task or evaluation box, such as evaluation box 806. FIG. 8B is a pictorial diagram illustrating the exemplary user interface 800 resulting from selecting a student for additional communication. According to this example, after the teacher has selected a specific student, additional information is displayed regarding that student, such as window 808. A teacher may enter information directed to the student, such as in box 810, which may be transmitted to the student and displayed on the student's output device. Alternatively, the teacher may send an audio response, or combination of responses, as previously discussed.

According to one embodiment of the present invention, when configured as a networked environment 700, the tablet devices may be configured to little more than accept the user's unstructured input, display the input on the output device. In this configuration, determining whether a response should be presented to the user comprises sending the user's input to a server computer, such as the instructor computer 714, or some other computer connected to the network (not shown), that determines if a response should be provided, and if so, sends that response to the tablet device. According to other aspects of the invention, a teacher at the instructor computer 714 may include the ability to control any or all aspects of the instructional feedback provided to the student in real-time. For example, if a teacher, monitoring a student's input activity, realizes that a particular student may be in need of additional instructional feedback, the teacher might alter the parameters for generating instructional feedback for that student, as well as the type of instructional feedback, such that, for example, appropriate instructional feedback is provided more frequently and immediately (i.e., as soon as a mistake is detected).

According to yet further aspects of the present invention (not shown), the unstructured input from a user may be recorded and stored for future analysis, comparison, or playback. For example, information received on a tablet device, such as tablet device 702, is recorded and may be played back to the user as additional feedback, perhaps to highlight what the user did correctly or not. Alternatively, user input may be stored and later retrieved by an instructor on the instructor computer 714 and replayed in order to evaluate the user's performance. Still further, the user's input information may be compared, or evaluated, to previous efforts, or to other user's efforts, in order to determine progress or relative performance in relation to others. Clearly, the user's input information may be advantageously used or evaluated in a variety of scenarios, and should not be construed as limited to any particular use.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computing device for providing instructional responses to a user, the computing device comprising:
a processor;
an input device; and
an output device;
wherein the computing device, in response to a task presented to a user:
accepts unstructured input from the user on the input device; and
determines whether an instructional response should be output.

2. The computing device of claim 1, wherein in response to a task presented to a user, the computing device further displays the unstructured input on the output device;

3. The computing device of claim 1, wherein the computing device determines whether an instructional response should be output while the computing device accepts unstructured input from the user.

4. The computing device of claim 1, wherein the computing device determines whether an instructional response should be output according to the accuracy of the unstructured input in regard to the presented task.

5. The computing device of claim 4, wherein if an instructional response should be output, the computing device further outputs an instructional response to the user on the output device, and wherein the instructional response is a visual response, an audio response, or both a visual and audio response.

6. The computing device of claim 4, wherein the computing device is connected to an instructor's computer over a communication network, and wherein the computing device further sends the user's unstructured input to the instructor's computer over the communication network.

7. The computing device of claim 6, wherein the computing device determines whether an instructional response should be output by querying whether a user at the instructor's computer has generated a response.

8. A networked computing system for monitoring the activities of a plurality of students on computing devices in response to a presented task, the system comprising:
an instructor computer; and
a plurality of computing devices connected to the instructor computer via a communication network connection, wherein each computing device comprises an input module and an output module, and operable to:
accept unstructured user input via the input module; and
determine whether an instructional response should be provided to a user of the computing device.

9. The networked computing system of claim 8, wherein each computing device is further operable to display the unstructured input via the output module.

10. The networked computing system of claim 8, wherein each computing device is further operable to determine whether an instructional response should be provided to a user as the user enters the unstructured input.

11. The networked computing system of claim 8, wherein each computing device determines whether an instructional response should be provided to a user of the computing device according to the accuracy of the unstructured input in regard to the presented task.

12. The networked computing system of claim 11, wherein the plurality of computing devices are further operable to provide an instructional response to the user of a computing device if it is determined that an instructional response should be provided to the user, and wherein the instructional response is a visual response, an audio response, or both an audio or visual response.

13. The networked computing system of claim 11, wherein each computing device is further operable to send a user's unstructured input to the instructor's computer over the communication network.

14. The networked computing system of claim 8, wherein each computing device determines whether an instructional response should be output by querying whether the instructor's computer has generated a response.

15. A computer-readable medium having computer-readable instructions which, when executed on a computing device, carry out the method comprising:
accepting unstructured user input via an input module in response to a presented task; and
determining whether an instructional response should be output on the computing device.

16. The computer-readable medium of claim 15, the method further comprising outputting the unstructured user input via an output module.

17. The computer-readable medium of claim 15, wherein determining whether an instructional response should be output on the computing device is performed while accepting unstructured user input.

18. The computer-readable medium of claim 15, wherein determining whether an instructional response should be output on the computing device comprises determining whether an instructional response should be should be output on the computing device according to the accuracy of the unstructured input in regard to the presented task.

19. The computer-readable medium of claim 18, wherein the computing device further outputs an instructional response on the output device if it is determined that an instructional response should be output, and wherein the instructional response is a visual response, and audio response, or an audio and visual response.

20. The computer-readable medium of claim 18, wherein the method further comprises sending a user's unstructured input to an instructor's computer over a communication network, and wherein determining whether an instructional response should be output on the computing device comprises querying the instructor's computer as to whether a response should be output.
